(19) United States
(12) Patent Application Publication
(10) Pub. No.: US 2016/0034855 A1
(43) Pub. Date: Feb. 4, 2016

(54) LOCATION SHARING FOR EVENTS

(71) Applicant: Lenovo (Singapore) Pte. Ltd., Singapore (SG)

(72) Inventors: Spencer Michael Guy, Raleigh, NC (US); Russell Speight VanBlon, Raleigh, NC (US); Russell Stuart Gantman, Fuquay Varina, NC (US)

(21) Appl. No.: 14/446,533

(22) Filed: Jul. 30, 2014

(51) Int. Cl. G06Q 10/10

(52) U.S. Cl. CPC G06Q 10/1095

(57) ABSTRACT

One embodiment provides a method, comprising: sending, using a processor, an event having a specified time; receiving, using a processor, an acceptance of the event; and receiving, using a processor, location data of a user that accepted the event; wherein the location data is received for a predetermined time frame associated with the specified time of the event. Other embodiments are described and claimed herein.

### BACKGROUND

When people make plans to get together as a group, for example, for a meeting, group outing, and the like, someone, an event coordinator, may send a calendar event so that everyone included in the group can keep track of the details and be reminded of the event. However, in some cases people included in the group may be late to the event for a variety of reasons (e.g., traffic, running behind schedule, distracted, forgetfulness, etc.). When a person is running late they usually have to manually contact the event coordinator to let the event coordinator know they are going to be late getting to the event. Without this input the group may be left wondering whether the person is going to show up at all.

### BRIEF SUMMARY

In summary, one aspect provides a method, comprising: sending, using a processor, an event having a specified time; receiving, using a processor, an acceptance of the event; and receiving, using a processor, location data of a user that accepted the event; wherein the location data is received for a predetermined time frame associated with the specified time of the event.

A further aspect provides an information handling device, comprising: at least one processor; a memory device that stores instructions executable by the processor to: send an event having a specified time; receive an acceptance of the event; and receive location data of a user that accepted the event; wherein the location data is received for a predetermined time frame associated with the specified time of the event.

Another aspect provides a product, comprising: a storage device having code stored therewith, the code comprising: code that sends, using a processor, an event having a specified time; code that receives, using a processor, an acceptance of the event; and code that receives, using a processor, location data of a user that accepted the event; wherein the location data is received for a predetermined time frame associated with the specified time of the event.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for location sharing for an event.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When involved in a group event, for example, a meeting, group outing, team sport, and the like, many times someone will send a calendar event to those involved in the event. Sometimes a person who is involved in the group is not at the event location on time. In these cases, where a person included in a group event is running late, the person must contact (e.g., sending a text message, calling, etc.) either the event coordinator or someone else in the group to indicate that they are running late and will arrive within a specified time frame. Unfortunately, those estimated time frames frequently are inaccurate.

Some applications include a location sharing service, generally installed on an information handling device (e.g., smart phone, personal computer, tablet, personal digital assistant, etc.). A location sharing service may allow certain people to view the location of the user. However, with current location sharing services the location of the user is either shared publically (i.e., anyone can track the location of the user), shared with a specific person, or shared with a group of people that the user has given access to, usually friends and family. However, an option to allow location sharing for only those people included in the event is not included.

Current location sharing applications allow a user to either have location sharing turned on or turned off. Additionally, the user has to manually turn on the location sharing when the user wants to allow others to be able to know the user's location. A user also has to manually turn off the location sharing when they no longer want to share their location. Some applications may allow a user to set a time for the location sharing. For example, a user may be able to turn on location sharing at 8:00 a.m. and turn off location sharing at 5:00 p.m. everyday. However, if the user wants the location sharing turned on only for the duration of a specific event, they have to manually turn on the location sharing at their desired time and then manually turn off the location sharing at the end of the event. No location sharing service is automated to allow location sharing in response to an accepted event.

Accordingly, an embodiment provides a method of receiving access to location data for an event, where the data may be received by the event coordinator (i.e., the user sending the event) or data may be received by the entire group included in the event. An embodiment may send an event and upon receipt of acceptance of the event, an embodiment may then receive location data for the user who accepted the event. One embodiment may also send location data for the time surrounding the event (i.e., a time before and/or after the event). In one embodiment, this additional time may be selected by the user receiving the event or by the user sending the event. Once a user receives location data, one embodiment may allow the event group or event coordinator to determine whether a user is running late.

The illustrated example embodiments will be best understood by reference to the figures. The following description is intended only by way of example, and simply illustrates certain example embodiments.

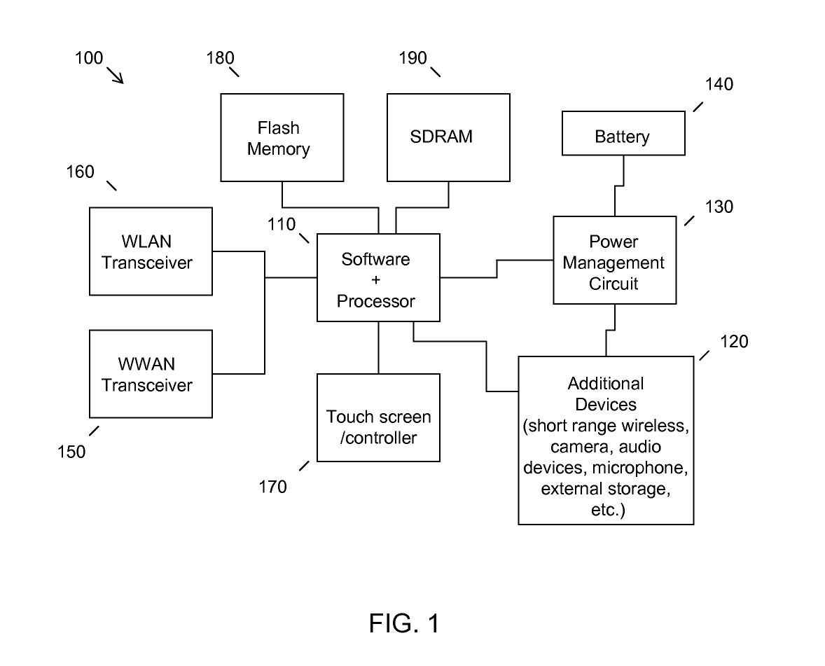

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120), for example a keyboard, camera, microphone, and the like, may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally devices 120 are commonly included, e.g., such as a camera, microphone, audio device, or other input devices. System 100 often includes a touch screen 170 for data input and display/rendering. System 100 also typically includes various memory devices, for example flash memory 180 and SDRAM 190.

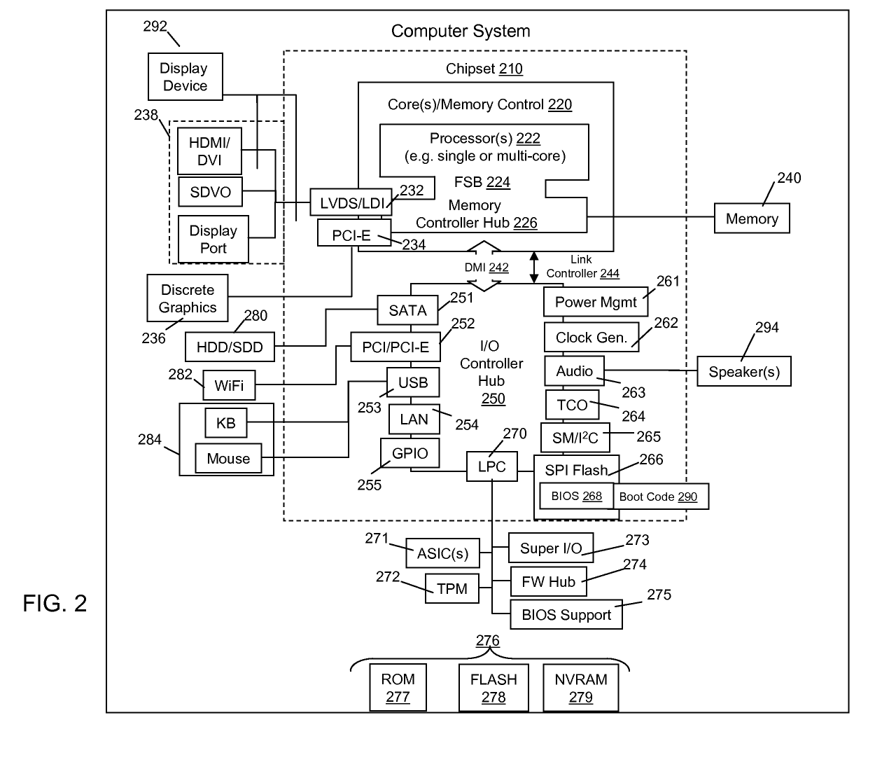

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a flat panel display, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mouse, camera, phone, microphone, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or other electronic devices which users use to send and receive events. For example, the circuitry outlined in FIG. 1 may be implemented in a tablet or smart phone embodiment, whereas the circuitry outlined in FIG. 2 may be implemented in a personal computer embodiment.

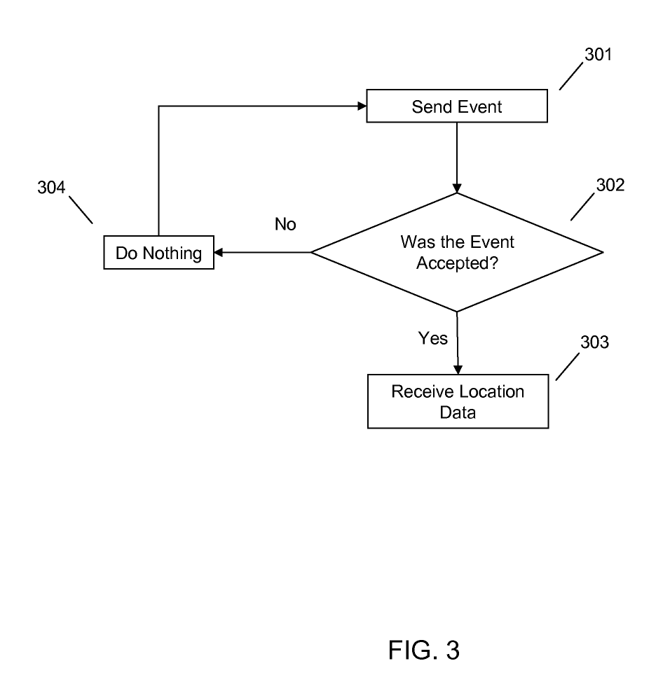

Referring now to FIG. 3, an embodiment may at 301 send an event notice for an event having a specified time. For example, in one embodiment an event coordinator (i.e., the person sending the event notice) may use an information handling device, such as that shown in FIG. 1 or FIG. 2, to send a calendar event to a group of friends. The calendar event may include details for the event, for example, the start and end time of the event, the location of the event, a description of the event, and the like. Upon acceptance, including tentative acceptance, of the event by the receiving users (i.e., the users receiving the event request), an embodiment may receive an indication that the receiving user(s) has accepted the event at 302. If the receiving user does not accept the event (for example, declining, no indication of accepting or declining, etc.), an embodiment may do nothing at 304. In one embodiment, location data sharing may be possible even if the user does not accept the event. In one embodiment, acceptance may include the user just adding the event to their calendar even without affirmative acceptance or if they decline or otherwise do not accept the event.

With the acceptance of the event at 302, an embodiment may receive location data at 303. The location data may be received for a predetermined time frame associated with the specified time of the event. For example, if an event coordinator sends a receiving user an event for a specific day for 6:00 p.m. to 8:00 p.m., the event coordinator may receive location data for the receiving user for that specific day from 6:00 p.m. to 8:00 p.m. In one embodiment, if the event is accepted at 302, the event coordinator may receive access to location sharing which will allow the event coordinator to receive location data of the user that accepted the event. This access may be granted in response to a request sent by the event coordinator, or may automatically be granted. If the user who accepted the event grants access to location data, the event coordinator may receive location data at 303. In one embodiment, the location sharing access may be granted to just the event coordinator. Alternatively or additionally, the location sharing access may be granted to all those users included in the group that have accepted the event.

In one embodiment, if a request to allow location sharing access is sent, the user who accepted the event (i.e., the receiving user) may receive a prompt requesting allowance of the location sharing. The receiving user may manually select whether to allow location sharing access. Alternatively, in one embodiment, a receiving user may automatically set a response. For example, a receiving user may change a setting on the information handling device to automatically accept all requests for location sharing associated with any event.

Alternatively or additionally, a receiving user may have a combination of manual and automatic selections for location sharing access requests. For example, a user may set an automatic response allowing location sharing access if the event coordinator is a contact included in a specific group (e.g., family, friend, work group, a specific person, etc.). However, if the event coordinator is not within the specified group, the receiving user would be prompted regarding allowing location sharing access. Alternatively or additionally, the automatic and manual responses may be tied to a specific location. For example, if a receiving user receives a request for location sharing access for an event at work, the user may have an automatic response to grant such requests. If however, the event is located outside the work place, the receiving user may receive a prompt to allow location sharing access.

In one embodiment, the predetermined time frame associated with the specified time of the event may also include an additional time frame. This time frame may be before the start of the event, after the end of the event, or both. For example, if the event coordinator sends an event that is from 5:00 a.m. to 8:00 a.m., and the receiving user accepts the event, the location data may be shared from 4:45 a.m. to 8:15 a.m. This additional time frame may be automatic. For example, a setting is included in which granted location sharing access always includes an additional fifteen minutes on either side of the event.

Alternatively or additionally, in one embodiment the additional time frame may be selected by the event coordinator. For example, when the event coordinator sends the event, the information handling device may prompt the coordinator regarding whether the location data sharing should include an additional time and, if so, how much additional time. Alternatively or additionally, the event coordinator may set up an automatic time frame so the event coordinator would not be prompted every time. For example, the event coordinator could adjust a setting that adds an additional thirty minutes before the event starts to the location data time frame. All location data requests or receipts would include this additional thirty minutes.

In one embodiment, the additional time frame may be selected by the receiving user. For example, when the receiving user receives a sent event and accepts that event, the receiving user may be prompted to select whether the receiving user wants to add an additional amount of time to the location data sharing. The receiving user may additionally be prompted for how much to add to the event. Alternatively or additionally, the receiving user may set up an automatic time frame for all location data grants. For example, the receiving user may adjust a setting that adds an additional ten minutes at the end of an event to the location data time frame for any granted location data sharing.

In one embodiment, the receiving user may be allowed to overwrite the time frame selected or requested by the event coordinator. For example, if the event coordinator has sent an event with location data sharing for the time of the event plus five minutes additional at both the start and end of the event, a receiving user may be able to overwrite this time and change the location data sharing to be equal to the time frame of the event with no additional time. The overwriting may be done by prompting the receiving user. For example, the receiving user is notified the event coordinator has added additional time and the prompt requests the receiving user to approve the additional time. If the receiving user does not approve the additional time, a prompt may ask the receiving user to enter an allowable time frame. Alternatively the overwriting may be done automatically. For example, the receiving user has set a setting that automatically gives an additional five minutes of location data sharing at the beginning of the event and any location data sharing grants will have the additional five minutes even if the event coordinator requested or set a different amount of time.

Once the event coordinator and/or event group has received location data at 303, the location data may include displaying a map indicating the current location of the receiving user. The map may also include the location of the event. The map may also include an estimated time of arrival (i.e., when will the receiving user arrive) or an estimate of how long it will take for a person to travel from the receiving user's current location to the event location. In one embodiment, this map may also include additional details, for example traffic, best route, alternative route, construction locations, directions, and the like. In one embodiment, the location data may include an indication, for example, displaying a time of arrival, displaying an amount time until arrival, displaying a countdown timer, displaying a clock, etc., indicating an estimate of how long it will take the receiving user to arrive at event location. This indication may be generated by the event coordinator's information handling device or it may be received from the receiving user's information handling device. For example, the event coordinator's information handling device may calculate an estimated time of arrival based upon knowing the receiving user's location and the event location. Alternatively, the receiving user's information handling device may send an estimate to the event coordinator.

In one embodiment, the location data sharing may additionally include the ability to automatically send a message (e.g., a text message, automated phone call, calendar update, etc.) to the event coordinator and/or event group from the receiving user indicating how long it will take the receiving user to arrive at the event location. For example, if a receiving user is at a location twelve minutes away from the event location the event coordinator may receive a calendar update indicating that the receiving user is twelve minutes away from the event location.

In one embodiment, the message may be sent once the receiving user is running late (i.e., not at the event location at the start time of the event). For example, if the event starts at 6:30 p.m. a text message may be sent to the event coordinator and/or event group at 6:30 p.m. stating that the receiving user is five minutes away from the event location. Alternatively or additionally, this message may be sent at the beginning of the location data sharing time frame. For example, if the location data sharing includes a time for an additional twenty minutes prior to the event, an automated phone call may be sent to the event coordinator and/or event group indicating that the receiving user is within fifteen minutes of the event location at twenty minutes until the event starting time.

Accordingly, as illustrated by the example embodiments and the figures, an embodiment provides a method in which an event coordinator can send an event to a group of people. Upon acceptance of the event, an embodiment may also allow the event coordinator and/or event group to receive location data. Alternatively, an embodiment may receive access to location sharing, which allows receipt of location data of the receiving user. In an embodiment, the location sharing access may be limited to the time frame associated with the event or it may include an additional time frame before an event, after an event, or both before and after the event.

The location data may allow an event coordinator to view a map showing the location of the receiving user. One embodiment may automatically send a message associated with the starting time of location data sharing informing the event coordinator when the receiving user may arrive at the event location. Thus, one embodiment allows a receiving user to only allow location data sharing for a time frame associated with an event, which may include an additional time frame before or after an event. Additionally, the location data does not have to be shared with everyone and can be narrowed to just those people included in the event or the event coordinator.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages or machine code. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
sending, using a processor, an event having a specified time;
receiving, using a processor, an acceptance of the event; and
receiving, using a processor, location data of a user that accepted the event;
wherein the location data is received for a predetermined time frame associated with the specified time of the event.

2. The method of claim 1, further comprising receiving access to location sharing allowing receipt of location data of the user that accepted the event.

3. The method of claim 1, wherein the predetermined time frame includes an additional time frame before a starting time of the event.

4. The method of claim 1, wherein the predetermined time frame includes an additional time frame after an ending time of the event.

5. The method of claim 1, further comprising displaying a map indicating a current location of a user that accepted the event.

6. The method of claim 1, further comprising displaying a time indicating an estimate of how long it will take the user that accepted the event to arrive at a location of the event.

7. The method of claim 1, further comprising receiving an automated message from a user that accepted the event indicating how long it will take the user to arrive at the event location.

8. The method of claim 1, further comprising generating an indication associated with a user that accepted the event indicating how long it will take the user to arrive at the event location.

9. The method of claim 7, wherein the message is received within a predetermined time of a starting time of the event.

10. The method of claim 1, wherein the predetermined time frame comprises an amount of time indicated by a device from the group consisting of: a device of the user that accepted the event and a device of a user sending the event.

11. An information handling device, comprising:
at least one processor;
a memory device that stores instructions executable by the processor to:
send an event having a specified time;
receive an acceptance of the event; and
receive location data of a user that accepted the event;
wherein the location data is received for a predetermined time frame associated with the specified time of the event.

12. The information handling device of claim 11, wherein the instructions are further executable by the processor to receive access to location sharing allowing receipt of location data of the user that accepted the event.

13. The information handling device of claim 11, wherein the predetermined time frame includes an additional time frame before a starting time of the event.

14. The information handling device of claim 11, wherein the predetermined time frame includes an additional time frame after an ending time of the event.

15. The information handling device of claim 11, wherein the instructions are further executable by the processor to receive display data for displaying a map indicating the current location of a user that accepted the event.

16. The information handling device of claim 11, wherein the instructions are further executable by the processor to send display data for displaying a map indicating the current location of a user that accepted the event.

17. The information handling device of claim 11, wherein the instructions are further executable by the processor to receive display data for displaying a time indicating an estimate of how long it will take the user that accepted the event to arrive at a location of the event.

18. The information handling device of claim 11, wherein the instructions are further executable by the processor to send display data for displaying a time indicating an estimate of how long it will take a user that accepted the event to arrive at the event location.

19. The information handling device of claim 11, wherein the instructions are further executable by the processor to receive an automated message from a user that accepted the event indicating how long it will take the user to arrive at the event location.

20. The information handling device of claim 19, wherein the message is received within a predetermined time of a starting time of the event.

21. The information handling device of claim 11, wherein the predetermined time frame comprises an amount of time indicated by a device from the group consisting of: a device of the user that accepted the event and a device of a user sending the event.

22. A product, comprising:
a storage device having code stored therewith, the code comprising:
code that sends, using a processor, an event having a specified time;
code that receives, using a processor, an acceptance of the event; and
code that receives, using a processor, location data of a user that accepted the event;
wherein the location data is received for a predetermined time frame associated with the specified time of the event.
